(19) United States
(12) Patent Application Publication
(10) Pub. No.: US 2016/0104980 A1
(43) Pub. Date: Apr. 14, 2016

(54) CONNECTING APPARATUS FOR ELECTRONIC APPLIANCE

(71) Applicant: Oxti Corporation, Taipei (TW)

(72) Inventor: Chih Feng HO, Taipei (TW)

(21) Appl. No.: 14/509,222

(22) Filed: Oct. 8, 2014

(51) Int. Cl. H01R 13/70; H01R 13/46

(52) U.S. Cl. CPC H01R 13/70; H01R 13/46

(57) ABSTRACT

A connecting apparatus includes a housing having a connector for connecting to a cable device, and having one or more socket members for coupling to the electronic appliances, and having an engaging member for engaging with the electronic appliance. The housing includes one or more socket elements electrically connected to the housing with wires. The housing includes a switch for controlling a supplying of an electric energy to the socket members. The engaging member is selected from a notch formed in the housing for engaging with the electronic appliance. The electronic appliance includes a post engaged with the engaging member of the housing.

### BACKGROUND OF THE INVENTION

1. Field of the Invention

The present invention relates to a power connecting device, and more particularly to a power connecting apparatus including an improved structure or configuration for suitably attaching to electronic appliances and for allowing the electronic appliances to be easily and quickly and readily connected or coupled to the connecting apparatus.

2. Description of the Prior Art

Typical cable organizer or organizing or connecting apparatuses comprise a casing or housing having a plate or wall member which includes one or more openings or orifices or notches formed therein for receiving or engaging with the wires or cables and for winding and storing and organizing the wires or cables therein and for preventing the wires or cables from being disengaged or separated from the connecting apparatus, and for allowing the wires or cables to be electrically connected or coupled to the electronic appliances.

For example, U.S. Pat. No. 7,098,406 to Hammonds, U.S. Pat. No. 7,446,260 to Hammonds, U.S. Pat. No. 8,076,584 to Huang et al. and U.S. Pat. No. 8,668,160 to Cheng disclose several of the typical cable organizing devices each comprising a casing or housing having a compartment or chamber or one or more openings or orifices or notches formed therein for receiving or engaging with the wires or cables and for winding and storing and organizing the wires or cables therein and for preventing the wires or cables from being disengaged or separated from the casing or housing of the connecting apparatus.

However, the typical cable organizing devices may only be used to receive or engage with or organize the wires or cables, but may not be attached to the electronic appliances, and the electronic appliances may not be easily and quickly and readily connected or coupled to the connecting apparatus.

The present invention has arisen to mitigate and/or obviate the afore-described disadvantages of the conventional cable organizing or connecting apparatuses.

### SUMMARY OF THE INVENTION

The primary objective of the present invention is to provide a connecting apparatus including an improved structure or configuration for suitably attaching or mounting to the electronic appliances and for allowing the electronic appliances to be easily and quickly and readily connected or coupled to the connecting apparatus.

In accordance with one aspect of the invention, there is provided a connecting apparatus for electronic appliance, comprising a housing including a connector for connecting to a power source with a cable device, and including at least one socket member for coupling to an electronic appliance, and including an engaging member provided therein for engaging with the electronic appliance.

The housing includes at least one socket element electrically connected to the housing with a wire for selectively connecting or coupling to the electronic appliance. The housing includes a switch provided thereon for controlling a supplying of an electric energy to the socket member and/or to the socket element, or for switching on or off the socket member and/or the socket element.

The engaging member is selected from a notch formed in the housing for engaging with the electronic appliance and for attaching or mounting to the electronic appliance. The electronic appliance includes a post engaged with the engaging member of the housing for stably attaching or mounting or anchoring the housing to the electronic appliance.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a connecting apparatus in accordance with the present invention; and

FIG. 2 is a partial exploded view of the connecting apparatus.

### DETAILED DESCRIPTION OF THE PREFERRED EMBODIMENT

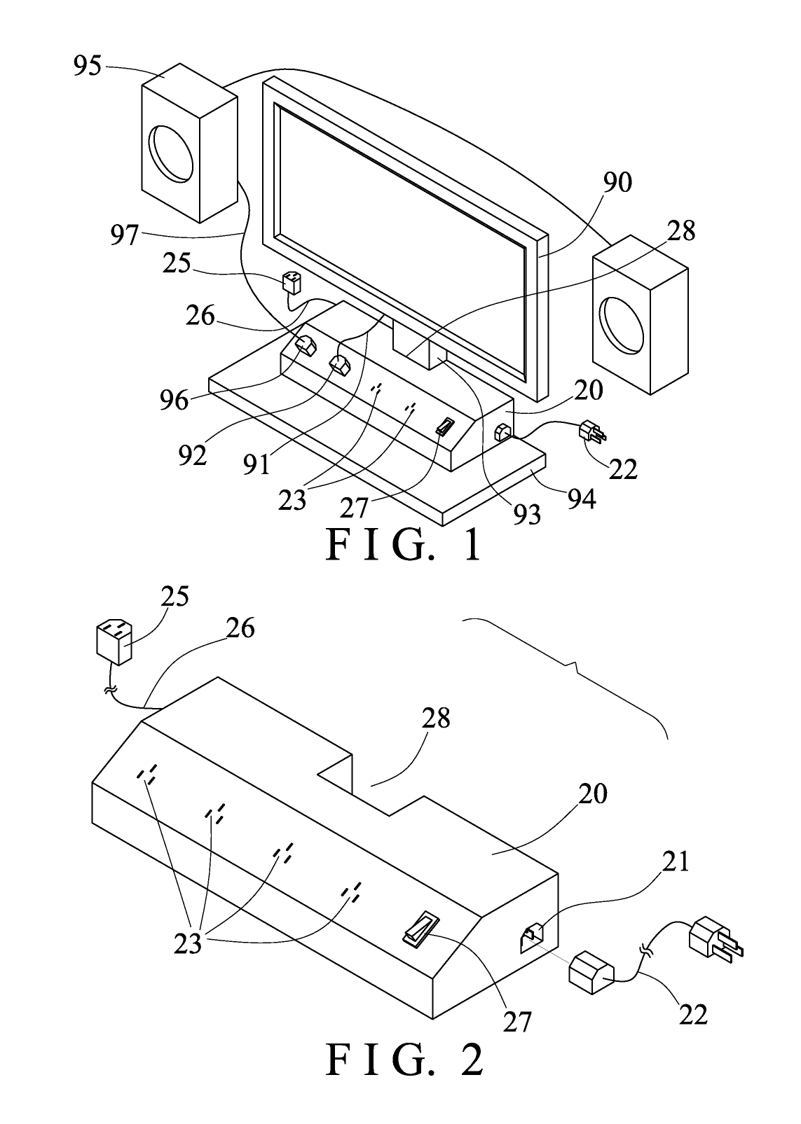

Referring to the drawings, and initially to FIG. 1, a connecting apparatus in accordance with the present invention comprises a receptacle or housing 10 including a socket or plug or connector 21 formed or provided thereon (FIG. 2) for connecting or coupling to a power station or power source (not illustrated) with a cable device 22 and for receiving the electricity or electric energy from the power station or power source, and the housing 20 includes one or more plugs or connectors or socket members 23 formed or provided thereon for connecting or coupling to the electronic objects or articles or appliances 90 with the cables 91 and/or the plugs 92 or the like.

The housing 20 may further include one or more further plugs or connectors or socket elements 25 electrically connected or coupled to the housing 20 with cables or wires 26 for connecting or coupling to the other electronic objects or articles or appliances (not illustrated), such as monitors, keyboards, antenna members, displayers, printers, computer stations, speakers, or the other peripherals. The housing 20 may further include a switch 27 formed or provided thereon for switching or controlling the supplying of the electricity or electric energy to the socket members 23 and/or the socket elements 25.

The housing 20 further includes an engaging member 28 formed or provided therein for receiving or engaging with the electronic appliance 90, such as monitors, keyboards, antenna members, displayers 90 or the like (FIG. 1), for example, the engaging member 28 is selected from an opening or orifice or recess or notch 28 formed in the housing 20 for receiving or engaging with the column or stud or post 93 of the electronic appliance 90, and the housing 20 may be attached or mounted or secured or coupled to the electronic appliance 90, and preferably supported on the bottom board 94 of the electronic appliance 90.

In operation, as shown in FIG. 1, the housing 20 may be suitably and solidly and stably supported on the bottom board 94 of the electronic appliance 90 and attached or mounted or secured or coupled to the electronic appliance 90, and the electronic appliance 90 may be easily and quickly and readily and electrically connected or coupled to either of the socket members 23 or the socket elements 25, such that the wires or cables for the electronic appliances 90 may be suitably received or engaged in and wound and stored and organized in the housing 20, and will not be exposed to interfere the users.

The other electronic articles or objects or appliances 95, such as monitors, keyboards, antenna members, displayers, printers, computer stations, speakers 95, or the other peripherals or the like may also be easily and quickly and readily and electrically connected or coupled to either of the socket members 23 or the socket elements 25 with cables 97 and/or plugs 96 or the like without additional extensions or the like, such that the housing 20 may be used or provided for easily and quickly and readily and electrically connecting or coupling to the electronic objects or articles or appliances 90, 95.

Accordingly, the connecting apparatus in accordance with the present invention includes an improved structure or configuration for suitably attaching to electronic appliances and for allowing the electronic appliances to be easily and quickly and readily connected or coupled to the connecting apparatus.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connecting apparatus for electronic appliance, comprising:
a housing including a connector for connecting to a cable device, and including at least one socket member for coupling to an electronic appliance, and including an engaging member provided therein for engaging with said electronic appliance.

2. The connecting apparatus as claimed in claim 1, wherein said housing includes at least one socket element electrically connected to said housing with a wire.

3. The connecting apparatus as claimed in claim 1, wherein said housing includes a switch provided thereon for controlling a supplying of an electric energy to said at least one socket member.

4. The connecting apparatus as claimed in claim 1, wherein said engaging member is selected from a notch formed in said housing for engaging with said electronic appliance.

5. The connecting apparatus as claimed in claim 1, wherein said electronic appliance includes a post engaged with said engaging member of said housing.
